(19) United States
(12) Patent Application Publication
(10) Pub. No.: US 2024/0073660 A1
(43) Pub. Date: Feb. 29, 2024

(54) POSITIONING SYSTEM AND POSITIONING METHOD BASED ON RADIO FREQUENCY IDENTIFICATION TECHNIQUES

(71) Applicant: INSTITUTE FOR INFORMATION INDUSTRY, Taipei City (TW)

(72) Inventors: YAO-SHUN YANG, TAIPEI CITY (TW); HUI-TZU HUANG, TAIPEI CITY (TW); JIAN-YING CHEN, TAIPEI CITY (TW); CHUAN-CHUAN WANG, TAIPEI CITY (TW)

(21) Appl. No.: 17/963,995

(22) Filed: Oct. 11, 2022

(30) Foreign Application Priority Data
Aug. 23, 2022 (TW) 111131586

(51) Int. Cl. H04W 4/44; G06V 20/56; G06V 20/62; H04W 4/029

(52) U.S. Cl. CPC H04W 4/44; G06V 20/588; G06V 20/625; H04W 4/029

(57) ABSTRACT

A positioning system and a positioning method based on radio frequency identification techniques (RFID) are provided. The positioning system includes in-vehicle devices, RFID readers and a server. The in-vehicle devices each includes a positioning device, an image capturing device and an image recognition module. The positioning device obtains a positioning location. The image capturing device captures a driving image. The image recognition module identifies adjacent vehicles, adjacent license plate information, and road attributes, and calculates relative location information. Each of the RFID readers reads a vehicle tag of one of the vehicles passing by, so as to mark a reference vehicle and generate reference vehicle information. A positioning adjustment module of the server determines whether the target vehicle is a reference vehicle, has been the reference vehicle or is a non-reference vehicle, and adjusts the positioning location of the target vehicle in different ways, accordingly.

### CROSS-REFERENCE TO RELATED PATENT APPLICATION

This application claims the benefit of priority to Taiwan Patent Application No. 111131586, filed on Aug. 23, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a positioning system and a positioning method, and more particularly to a positioning system and a positioning method based on radio frequency identification (RFID) techniques which can utilize an Internet of Vehicles (IoV) system to correct a positioning result of the global positioning system (GPS) in real time.

### BACKGROUND OF THE DISCLOSURE

In the existing positioning method using the global positioning system (GPS), a GPS module that is mounted on a vehicle in advance can be used to obtain a current location of the driving vehicle according to a signal interaction between the GPS module and the global satellite positioning system.

However, although the widely used GPS positioning technology provides a certain degree of accuracy, errors may still occur due to the relative positional relationship between the GPS module and satellite, atmospheric conditions and geographical conditions, since GPS signals transmitted between the GPS module and the global satellite positioning system are easily affected by the environment.

### SUMMARY OF THE DISCLOSURE

In response to the above-referenced technical inadequacies, the present disclosure provides a positioning system and a positioning method based on radio frequency identification (RFID) techniques which can utilize an Internet of Vehicles (IoV) system to correct a positioning result of the global positioning system (GPS) in real time.

In one aspect, the present disclosure provides a positioning system based on radio frequency identification (RFID) techniques, and the positioning system includes a plurality of in-vehicle devices, a plurality of RFID readers and a server. The in-vehicle devices are mounted on the vehicles, respectively, and each includes a positioning device, an image capturing device and an image recognition module. The positioning device is configured to obtain a positioning location. The image capturing device is configured to capture a driving image from a surrounding environment of the corresponding vehicle. The image recognition module is configured to identify at least one adjacent vehicle, at least one record of adjacent license plate information, and a road attribute of a road from the driving image, and to calculate at least one record of relative location information of the at least one adjacent vehicle. Each of the plurality of RFID readers is configured to read a vehicle tag of one of the vehicles passing by, so as to mark the vehicle passing by as a reference vehicle and generate reference vehicle information corresponding to the vehicle passing by. The server is communicatively connected with the plurality of RFID readers and each of the plurality of in-vehicle devices, and the server includes a location predicting module and a positioning adjustment module. The location predicting module is configured to, for each of multiple ones of the reference vehicles, perform a location prediction to generate a predicted location, and to calculate a confidence level corresponding to the predicted location. The positioning adjustment module is configured to perform the following steps for a target vehicle among the plurality of vehicles: determining whether the target vehicle is the reference vehicle, has been the reference vehicle or is a non-reference vehicle; in response to determining that the target vehicle is the reference vehicle, adjusting the positioning location of the target vehicle according to the corresponding road; in response to determining that the target vehicle has been the reference vehicle, adjusting the positioning location of the target vehicle according to the predicted location of the target vehicle in response to the predicted location of the target vehicle having the confidence level that is higher than a predetermined level; and in response to determining that the target vehicle is the non-reference vehicle, adjusting the positioning location of the target vehicle according to at least one of the at least one record of the adjacent license plate information, the at least one record of the relative location information and the road attribute.

In another aspect, the present disclosure provides a positioning method based on radio frequency identification (RFID) techniques, and the positioning method includes: mounting a plurality of in-vehicle devices on a plurality of vehicles, respectively, in which each of the plurality of in-vehicle devices includes a positioning device, an image capturing device and an image recognition module; performing the following steps for each of the in-vehicle devices: configuring the positioning device to obtain a positioning location; configuring the image capturing device to capture a driving image from surroundings of the corresponding vehicle; and configuring the image recognition module to identify at least one adjacent vehicle, at least one record of adjacent license plate information, and a road attribute of a road from the driving image, and to calculate at least one record of relative location information of the at least one adjacent vehicle. The positioning method further includes: configuring each of a plurality of RFID readers to read a vehicle tag of one of the vehicles passing by, so as to mark the vehicle passing by as a reference vehicle and generate reference vehicle information corresponding to the vehicle passing by; configuring a server to communicatively connected with the plurality of RFID readers and each of the plurality of in-vehicle devices; configuring a location predicting module of the server to, for each of multiple ones of the reference vehicles, perform a location prediction to generate a predicted location, and to calculate a confidence level corresponding to the predicted location; and configuring a positioning adjustment module to perform the following steps for a target vehicle among the plurality of vehicles: determining whether the target vehicle is the reference vehicle, has been the reference vehicle or is a non-reference vehicle; in response to determining that the target vehicle is the reference vehicle, adjusting the positioning location of the target vehicle according to the corresponding road; in response to determining that the target vehicle has been the reference vehicle, adjusting the positioning location of the target vehicle according to the predicted location of the target vehicle in response to the predicted location of the target vehicle having the confidence level that is higher than a predetermined level; and in response to determining that the target vehicle is the non-reference vehicle, adjusting the positioning location of the target vehicle according to at least one of the at least one record of the adjacent license plate information, the at least one record of the relative location information and the road attribute.

Therefore, in the positioning system and the positioning method based on the RFID techniques provided by the present disclosure, the following advantages are provided:

(1) Data and signals obtained by technical applications that integrate information and communication technology can be used to establish a mechanism capable of correcting GPS positioning locations and improving accuracy, in which relevant information obtained through RFID readers and in-vehicle devices when driving can be transmitted to a back-end platform to correct the deviated GPS locations through computation, thereby reducing errors.

(2) The image recognition mechanism is utilized to extract important elements from the driving image for subsequent operations.

(3) By performing the position prediction for the reference vehicle, the effective time of the reference vehicle can be extended which improves the availability of the position information related to the reference vehicle. In addition, whether or not the reference vehicle can be used as an updated reference vehicle can be determined according to the confidence level of the predicted location.

(4) Different adjustment mechanisms are provided for the reference vehicle and the non-reference vehicle. In addition to using the reference vehicle information to directly adjust the positioning position, it can also be used to lock the road for the non-reference vehicle and limit road options so as to correct the GPS positioning to the target route.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a positioning system based on a radio frequency identification techniques according to one embodiment of the present disclosure;

FIG. 2 is a functional block diagram of a server, in-vehicle devices, and RFID readers according to one embodiment of the present disclosure;

FIG. 3 is a schematic diagram of a driving image according to one embodiment of the present disclosure;

FIG. 4 is a flowchart of a positioning method based on RFID techniques according to one embodiment of the present disclosure;

FIG. 5 is a schematic top view showing that vehicle tags of vehicles passing by are read by an RFID reader according to one embodiment of the present disclosure;

FIG. 6 is a detailed flowchart of step S13 of FIG. 4; and

FIG. 7 is a detailed flowchart of step S17 of FIG. 4.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

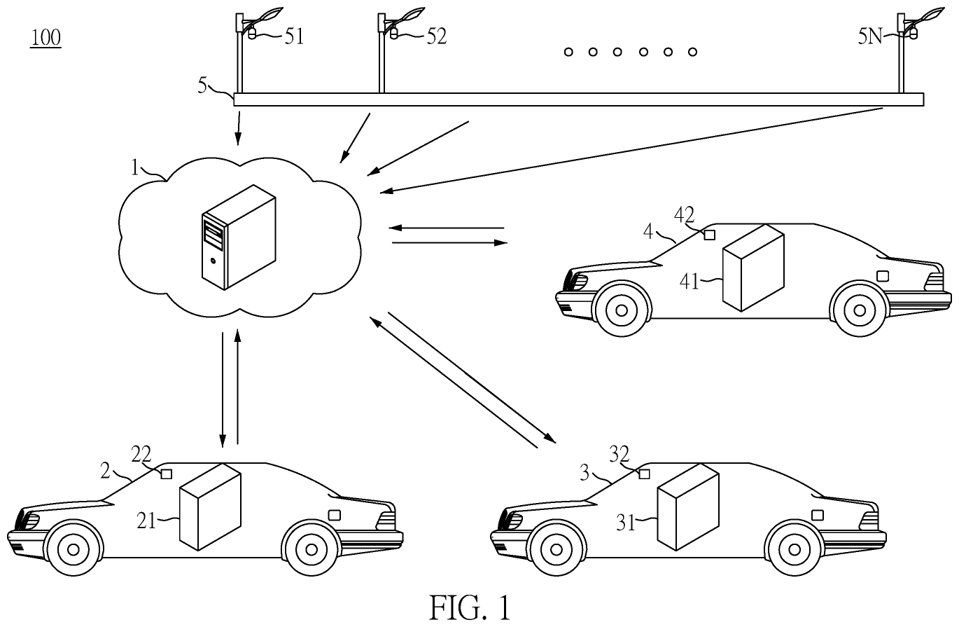

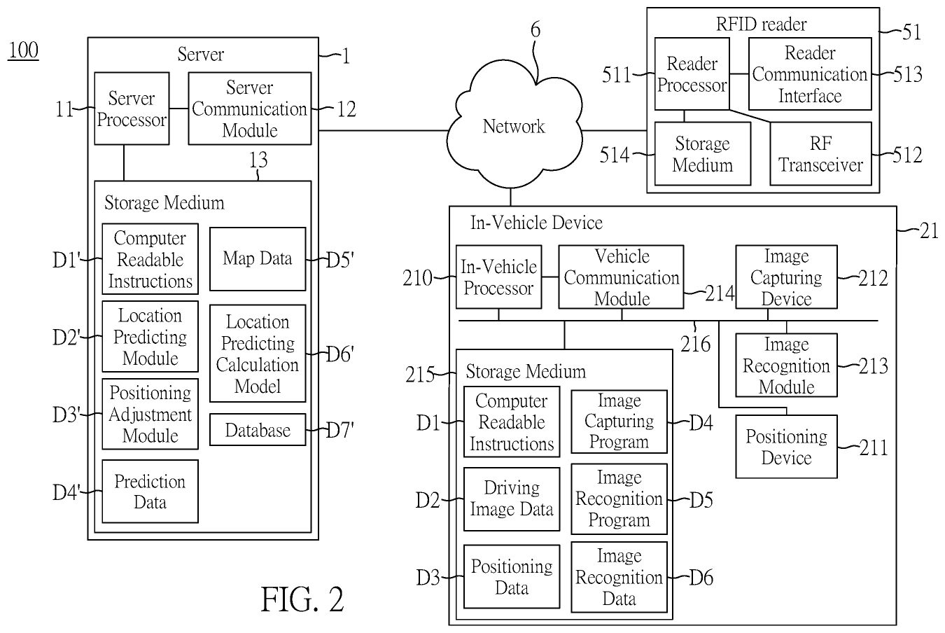

FIG. 1 is a schematic diagram of a positioning system based on radio frequency identification techniques according to one embodiment of the present disclosure, and FIG. 2 is a functional block diagram of a server, in-vehicle devices, and RFID readers according to one embodiment of the present disclosure. Referring to FIGS. 1 and 2, a first embodiment of the present disclosure provides a positioning system 100 based on radio frequency identification (RFID) techniques, which includes a server 1, in-vehicle devices 21, 31 and 41 and a plurality of RFID readers 51, 52, . . . , 5N.

The in-vehicle devices 21, 31, and 41 can be, for example, Vehicle-to-everything (V2X) devices, which are mounted on vehicles 2, 3 and 4 respectively, and the server 1 can be communicatively connected with the in-vehicle devices 21, 31, and 41 and the RFID readers 51, 52, . . . , 5N, for example, through the network 6, but the above is only an example, and the present disclosure is not limited thereto. Taking the in-vehicle device 21 as an example, the in-vehicle device 21 includes an in-vehicle processor 210, a positioning device 211, an image capturing device 212, an image recognition module 213, a vehicle communication module 214 and a storage medium 215. The in-vehicle processor 210, the positioning device 211, the image capturing device 212, the image recognition module 213, the vehicle communication module 214 and the storage medium 215 can be electrically coupled to each other through a bus 216.

The storage medium 215 can be, for example, but not limited to, a hard disk, a solid-state hard disk, or other storage devices that can be used to store data, which is configured to store at least a plurality of computer-readable commands D1, driving image data D2, positioning data D3, an image capturing program D4, an image recognition program D5 and image recognition data D6. The vehicle communication module 214 is configured to access the network under control of the in-vehicle processor 210, and can communicate with the server 1, for example.

The positioning device 211 is used to obtain a positioning location, and can be, for example, a global positioning system (GPS) device, which is configured to obtain a GPS location as the positioning location.

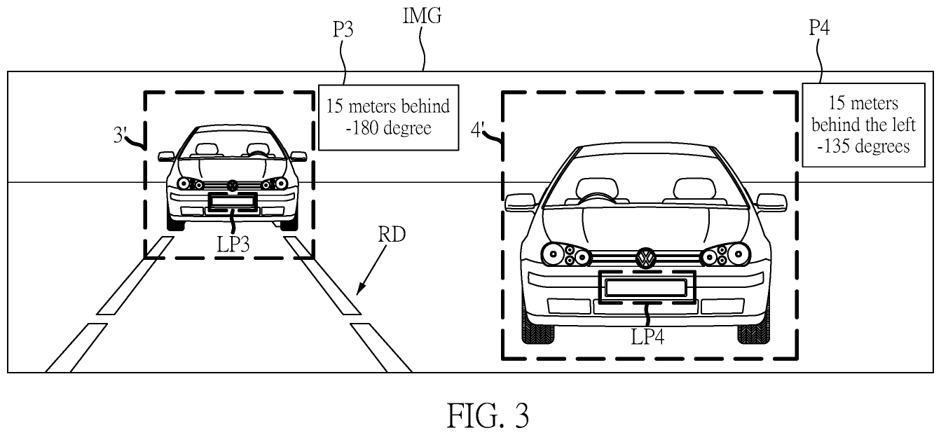

The image capturing device 212 can be, for example, a camera or a video camera, and is configured to capture a driving image IMG from a surrounding environment of the vehicle 2. Reference is made to FIG. 3, which is a schematic diagram of a driving image according to one embodiment of the present disclosure. As shown in FIG. 3, the image recognition module 213 can include a graphics processing unit configured to directly identify adjacent vehicles 3′ and 4′ and adjacent license plate information LP2 and LP3 from the driving image IMG, and to identify a road attribute of the road RD from the driving image IMG. The image recognition module 213 can further calculate relative location information P3 and P4 of the adjacent vehicle 3′ and 4′, respectively. Alternatively, the computer-readable instructions D1 and the image recognition program D5 can be executed by the in-vehicle processor 210 to implement all functions of the image recognition module 213 mentioned in the present disclosure. Data such as the adjacent license plate information LP2 and LP3, the road attributes, and the relative position information P3 and P4 of the adjacent vehicles 3′ and 4′ can be stored as the image recognition data D6.

The vehicle communication module 214 can be, for example, a wireless network communication device, and is configured to transmit the data such as the adjacent license plate information LP2 and LP3, the road attributes and the relative position information P3 and P4 of the adjacent vehicles 3′ and 4′ to the server 1. It should be noted that the in-vehicle devices 31 and 41 are basically the same as the in-vehicle device 21 and include all the components of the in-vehicle device 21, and are not repeated hereinafter.

In the embodiment of the present disclosure, the vehicles 2, 3 and 4 can be equipped with vehicle tags 22, 32 and 42, respectively, and carriers for carrying the vehicle tags 22, 32 and 42 can be radio frequency identification (RFID) tags, and forms of the carriers being implemented are not specifically limited in the present disclosure. As shown in FIG. 1, the RFID readers 51, 52, . . . , 5N can be arranged on lamp posts of the road 5 for reading vehicle tags of vehicles passing by the road 5. It should be noted that the RFID readers 51, 52, . . . , 5N can be arranged on multiple roads in a predetermined region that the positionings are predetermined to be performed on according to requirements, and the present disclosure does not limit the method for arranging the RFID readers on each road and a quantity of the RFID readers.

For example, the RFID reader 51 can include a reader processor 511, a radio frequency (RF) transceiver 512, a reader communication interface 513 and a storage medium 514. The reader processor 511 can be configured to control the RF transceiver 512 to send RF signals to a predetermined area.

If the RFID tag is used as the carrier, when the RFID reader 51 detects the RFID tag, the vehicle tag of the vehicle is obtained from the RFID tag. More specifically, when a distance between the RFID reader 51 and the RFID tag is less than or equal to a propagation distance of the RF signals, the RF transceiver 512 can receive the RF signals returned by the RFID tag, which is regarded as the RFID reader 51 reads the RFID tag. In this way, the RFID reader 51 can parse the vehicle tag of the vehicle from the received RF signals and store the vehicle tag in the storage medium 514. RFID tags can be classified into passive RFID tags and active RFID tags according to whether a power source is carried thereby or not, and implementations of the RFID tags are not limited in the embodiment of the present disclosure. The RFID reader 51 can communicatively connect with the server 1 through the reader communication interface 513, to mark the vehicles passing by as reference vehicles, and the obtained vehicle tag (which may include the license plate information of the vehicle passing by), pass time and a location that the vehicle passes stored and transmitted to the server 1 as the reference vehicle information.

The server 1 includes a server processor 11, a server communication module 12 and a storage medium 13. The server processor 11 is electrically coupled to the server communication module 12 and the storage medium 13. The storage medium 13 can be, for example, but not limited to, a hard disk, a solid-state hard disk, or other storage devices that can be used to store data. The storage medium 13 is configured to store at least a plurality of computer-readable instructions Dr, a location predicting module D2′, a positioning adjustment module D3′, prediction data D4′, map data D5′, a location predicting calculation model D6′ and a database D7′. The server communication module 122 is configured to access the network under control of the server processor 11, and can communicate with the in-vehicle devices 21, 31 and 41 and the RFID readers 51, 52, . . . , 5N through the network 6. In addition, although the location predicting module D2′ and the positioning adjustment module D3′ shown in FIG. 2 are implemented in forms of software, however, they can also be implemented in forms of hardware. The above are only examples, and the present disclosure is not limited thereto.

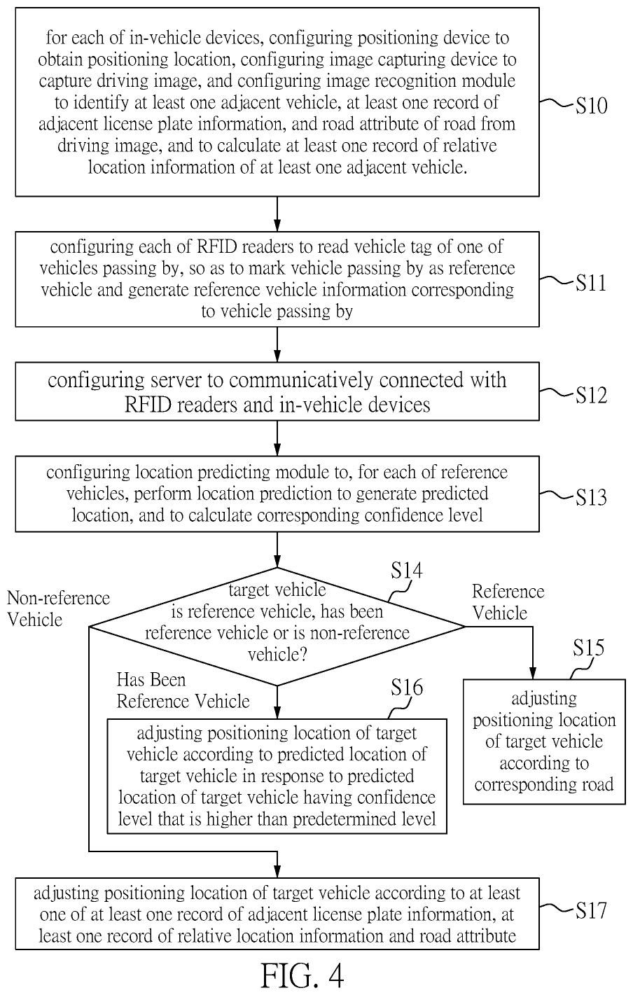

FIG. 4 is a flowchart of a positioning method based on RFID techniques according to one embodiment of the present disclosure. Referring to FIG. 4, one embodiment of the present disclosure provides a positioning method based on the RFID techniques, and the positioning method is suitable for the aforementioned positioning system 100 and can include at least the following steps:

Step S10: for each of the in-vehicle devices, configuring the positioning device to obtain a positioning location, configuring the image capturing device to capture a driving image, and configuring the image recognition module to identify at least one adjacent vehicle, at least one record of adjacent license plate information, and a road attribute of a road from the driving image, and to calculate at least one record of relative location information of the at least one adjacent vehicle.

As shown in FIG. 3, the vehicle 2 can be used as a target vehicle, the positioning device 211 can be used to obtain the positioning location, the image capturing device 212 can be used to capture a driving image IMG from the surrounding environment, and the vehicle processor 210 can be used to directly identify the adjacent vehicles 3′ and 4′ and the adjacent license plate information LP3 and LP4, to identify a road attribute of the road RD from the driving image IMG, and to calculate the relative position information P3 and P4 of the adjacent vehicles 3′ and 4′.

In some embodiments, the adjacent vehicles 3′ and 4′ and the adjacent license plate information LP3 and LP4 can be identified from the driving image IMG through an object recognition model. For example, the object recognition model can be, for example, a trained YOLO (You Only Look Once) model, and a training process roughly includes creating a dataset of existing vehicle images, extracting multi-scale features of vehicles in the dataset through the convolutional neural network of the YOLO model, and training the neural network to recognize vehicle images. Since this method is a training method of an object recognition model known to those skilled in the art, details of the training method are not repeated hereinafter.

Next, the relative position information P3 and P4 of the adjacent vehicles 3′ and 4′ can be calculated according to locations of the adjacent vehicles 3′ and 4′ and the adjacent license plate information LP3 and LP4 in the driving image IMG. For example, the relative position information P3 and P4 can be used to calculate orientations, distances and azimuth angles of the adjacent vehicles 3′ and 4′ with respect to the target vehicle as shown in FIG. 2.

Thereafter, the adjacent license plate information LP3 and LP4 can be marked, and a text recognition model can be used to identify exact license plate numbers in the corresponding adjacent license plate information LP3 and LP4. The text recognition model can be, for example, a CRNN model, which is a convolutional loop neural network structure and is used to solve the problem of image-based sequence recognition, especially the problem of scene text recognition.

In other embodiments, another object recognition model can also be used to identify the road attributes of the road RD from the driving image IMG, and the road attributes include road types (for example, elevated or flat roads can be identified) and a quantity of lanes. The another object recognition model can be, for example, an object recognition model such as VGG-16, VGG-S, and GoogLeNet which can be used for large-scale image classification.

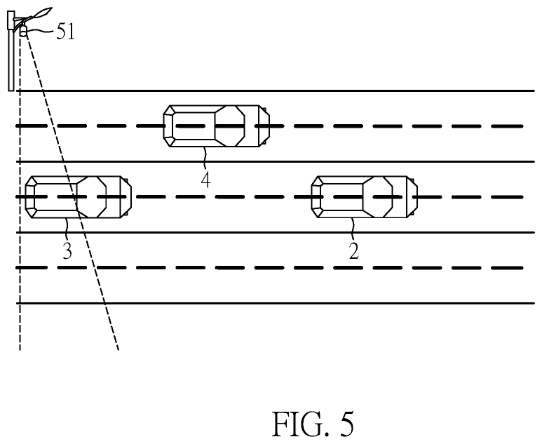

Step S11: configuring each of the plurality of RFID readers to read a vehicle tag of one of the vehicles passing by, so as to mark the vehicle passing by as a reference vehicle and generate reference vehicle information corresponding to the vehicle passing by. FIG. 5 is a schematic top view showing that vehicle tags of vehicles passing by are read by an RFID reader according to one embodiment of the present disclosure. As shown in FIG. 5, the RFID reader 51 can obtain the vehicle tags 22, 32 and 42 of the passing vehicles 2, 3 and 4 from the RFID tags, respectively, and at the same time mark the passing vehicles 2, 3 and 4 as reference vehicles, then the obtained vehicle tags 22, 32 and 42 (which may include the license plate information of the passing vehicles), the pass time and the pass location are stored and transmitted to the server 1 as the reference vehicle information.

Step S12: configuring the server to communicatively connect with the plurality of RFID readers and the plurality of in-vehicle devices.

Step S13: configuring the location predicting module to, for each of the reference vehicles, perform a location prediction to generate a predicted location, and to calculate a confidence level corresponding to the predicted location.

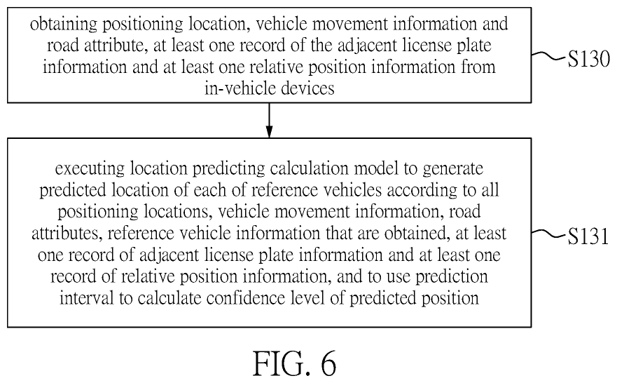

Reference is made to FIG. 6, which is a detailed flowchart of step S13 of FIG. 4. As shown in FIG. 6, step S13 further includes the following steps:

Step S130: obtaining the positioning location, vehicle movement information and the road attribute, the at least one record of the adjacent license plate information and the at least one relative position information from the plurality of in-vehicle devices.

Step S131: executing the location predicting calculation model to generate the predicted location of each of the reference vehicles according to all the positioning locations, the vehicle movement information, the road attributes, the reference vehicle information that are obtained, the at least one record of the adjacent license plate information and the at least one record of the relative position information, and to use a prediction interval to calculate the confidence level of the predicted position.

In detail, in order to prolong timeliness of the reference vehicle marked by the RFID reader and increase availability of relevant information of the reference vehicle, the vehicle previously marked as the reference vehicle can be further used to perform a location prediction and simultaneously calculates the confidence level by using the location predicting calculation model D6′. For example, the obtained data from the in-vehicle devices, including the positioning information such as the positioning locations, direction angles and speeds of the vehicles obtained in the previous step, as well as the obtained road attributes, such as locations of branches, shapes and lengths of the roads, can be input a hidden Markov model (HMM), a Markov model, or a long short-term memory (LSTM) algorithm can be executed, to integrate the above data to predict possible moving locations of the reference vehicles as the predicted locations, and finally the prediction interval is used to calculate the confidence levels corresponding to the predicted locations. Moreover, the predicted location and the corresponding confidence level can be stored as the prediction data D4′, which can be used, in subsequent steps, to assist in adjusting possibly deviated GPS locations for specific types of the vehicles.

Referring again to FIG. 1, the positioning method further includes performing the following steps S14, S15, S16 and S17 for the target vehicle among the vehicles by (the positioning adjustment module D3′ of) the server 1.

Step S14: determining whether the target vehicle is the reference vehicle, has been the reference vehicle or is a non-reference vehicle. This step will provide different adjustment methods for the positioning locations according to current characteristics of the target vehicle.

In response to determining that the target vehicle is the reference vehicle in step S14, the positioning method proceeds to step S15: adjusting the positioning location of the target vehicle according to the corresponding road. For example, as shown in FIG. 5, within a predetermined period of time after the target vehicle (e.g., the vehicle 2) passes by the RFID reader 51, the reference vehicle information associated with the vehicle 2 will be regarded as highly referenced and valid. Therefore, the target vehicle can be determined as the reference vehicle within the predetermined time, and a current (GPS) positioning location of the target vehicle (for example, the vehicle 2) can be corrected directly according to the speed and the driving direction of the vehicle 2 and a location of the RFID reader 51, and it can reasonably be expected that an accuracy of the corrected positioning location is extremely high.

In response to determining that the target vehicle has been the reference vehicle in step S14, the positioning method proceeds to step S16: adjusting the positioning location of the target vehicle according to the predicted location of the target vehicle in response to the predicted location of the target vehicle having the confidence level that is higher than a predetermined level. For example, after the predetermined time is elapsed after the target vehicle (e.g., the vehicle 2) passed by the RFID reader 51, the reference vehicle information associated with the vehicle 2 can be regarded as moderately referenced and not necessarily valid. Therefore, in response to exceeding the predetermined time after the target vehicle (e.g., the vehicle 2) passed by the RFID reader 51, it is necessary to further determine a possible location of the target vehicle. However, if the server 1 determines that the target vehicle 2 has passed the RFID reader 51, and the predicted location obtained in step S13 has the corresponding confidence level being sufficiently high, the target vehicle can be marked as an updated reference vehicle, and the current (GPS) positioning location of the target vehicle (e.g., the vehicle 2) can be corrected according to the predicted location. the corrected positioning position can still maintain a certain accuracy. It can reasonably be expected that an accuracy of the corrected positioning location can still be maintained to a certain extent.

In response to determining that the target vehicle is neither the reference vehicle nor the updated reference vehicle in step S14, the target vehicle is determined to be the non-reference vehicle, and the positioning method proceeds to step S17: adjusting the positioning location of the target vehicle according to at least one of the at least one record of the adjacent license plate information, the at least one record of the relative location information and the road attribute. In detail, after the target vehicle (e.g., vehicle 2) passes by the RFID reader 51 far beyond the predetermined time, it can be reasonably inferred that the reference vehicle information associated with the vehicle 2 obtained by the RFID reader 51 is no longer reference, this also greatly affects the confidence level in the predicted location generated for the target vehicle. Therefore, time after passing by the RFID reader 51 can be used as a reference. In response to determining that the target vehicle is not the reference vehicle and the confidence level of the predicted location is not high enough, it is necessary to further correct the positioning information of the target vehicle according to the information identified from the driving image IMG and the map data D5′ stored in the server 1.

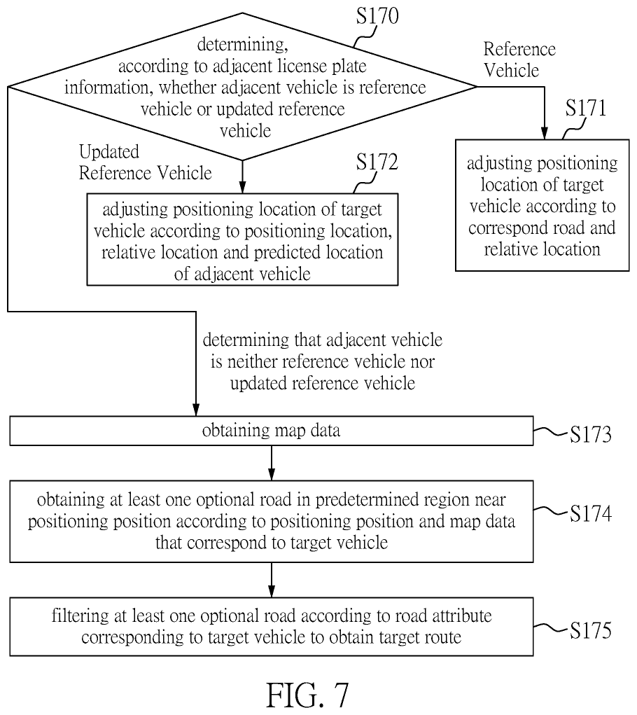

Reference is made to FIG. 7, which is a detailed flowchart of step S17 of FIG. 4. As shown in FIG. 7, in step S17, the following steps are further performed for each of the adjacent vehicles:

Step S170: determining, according to the adjacent license plate information, whether the adjacent vehicle is the reference vehicle or the updated reference vehicle (i.e., the adjacent vehicle has been the reference vehicle and the confidence level of the corresponding predicted location is higher than the predetermined level).

In response to determining that the target vehicle is the reference vehicle, the positioning method proceeds to step S171: adjusting the positioning location of the target vehicle according to the road and the relative location that correspond to the adjacent vehicle.

In other words, similar to the aforementioned adjustment manners, in this step, the location of the adjacent vehicle is adjusted first. If any reference vehicle (that is, a vehicle that has just passed the RFID reader) appears in the adjacent vehicles, a location of the adjacent vehicle that is highly accurate can be obtained first, and then a relative position of the adjacent vehicle with respect to the target vehicle can be identified from the driving image, thereby adjusting the positioning location of the target vehicle.

In response to determining that the adjacent vehicle has been the reference vehicle and the confidence level of the corresponding predicted location is higher than the predetermined level (that is, conditions for being the updated reference vehicle are met), the positioning method proceeds to step S172: adjusting the positioning location of the target vehicle according to the positioning location, the relative location and the predicted location of the adjacent vehicle. If the above-defined updated reference vehicle appears in the adjacent vehicles (that is, the confidence level of the predicted location is still high enough), the relative position of the adjacent vehicle with respect to the target vehicle can be identified from the driving image, thereby adjusting the positioning location of the target vehicle.

However, in response to determining that the at least one adjacent vehicle is not the reference vehicle, and the at least one adjacent vehicle has not been the reference vehicle and the confidence level of the corresponding predicted location is not higher than the predetermined level, then the positioning adjustment module is further configured to perform the following steps S173, S174, S175 and S176.

Step S173: obtaining map data.

Step S174: obtaining at least one optional road in a predetermined region near the positioning position according to the positioning position and the map data that correspond to the target vehicle.

Step S175: filtering the at least one optional road according to the road attribute corresponding to the target vehicle to obtain a target route.

Step S176: adjusting the positioning location of the target vehicle according to the target route.

In detail, in steps S173 to S176, road attributes such as county roads, township roads, urban roads, village connecting roads and bridges can be identified from the driving images, and the map data D5′ further referenced to narrow down optional road sections, and finally the GPS position possibly deviated are corrected to the target route. For example, in cases that the positioning is performed by using the GPS device, since a height remains unknown, it is impossible to determine whether the target vehicle is driving on the bridge or under the bridge. At this time, the possible road options can be further narrowed from the driving image IMG to improve the accuracy of the positioning.

### Beneficial Effects of the Embodiments

In conclusion, in the positioning system and the positioning method based on the RFID techniques provided by the present disclosure, the following advantages are provided:
(1) Data and signals obtained by technique applications that integrating information and communication technology can be used to establish a mechanism capable of correcting GPS positioning locations and improve accuracies, in which relevant information obtained during driving through RFID readers and in-vehicle devices can be transmitted to a back-end platform to correct the deviated GPS locations through calculation, thereby reducing errors.
(2) The image recognition mechanism is utilized to extract important elements from the driving image for subsequent operations.
(3) By performing the position prediction for the reference vehicle, the timeliness of the reference vehicle can be extended to improve the availability of the position information related to the reference vehicle. In addition, whether or not the reference vehicle can be used as an updated reference vehicle can be determined according to the confidence level of the predicted location.
(4) Different adjustment mechanisms are provided for the reference vehicle and the non-reference vehicle. In addition to using the reference vehicle information to directly adjust the positioning position, it can also lock the road for the non-reference vehicle and limit the optional roads to correct the GPS positioning to the target route.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A positioning system based on radio frequency identification (RFID) techniques, the positioning system comprising:
a plurality of in-vehicle devices mounted to a plurality of vehicles, respectively, wherein each of the plurality of in-vehicle devices includes:
a positioning device configured to obtain a positioning location;
an image capturing device configured to capture a driving image from a surrounding environment of the corresponding vehicle; and
an image recognition module configured to identify at least one adjacent vehicle, at least one record of adjacent license plate information, and a road attribute of a road from the driving image, and to calculate at least one record of relative location information of the at least one adjacent vehicle;
a plurality of RFID readers, each of which is configured to read a vehicle tag of one of the vehicles passing by, so as to mark the vehicle passing by as a reference vehicle and generate reference vehicle information corresponding to the vehicle passing by; and
a server communicatively connected with the plurality of RFID readers and each of the plurality of in-vehicle devices, wherein the server includes:
a location predicting module configured to, for each of multiple ones of the reference vehicles, perform a location prediction to generate a predicted location, and to calculate a confidence level corresponding to the predicted location; and
a positioning adjustment module configured to perform the following steps for a target vehicle among the plurality of vehicles:
determining whether the target vehicle is the reference vehicle, has been the reference vehicle or is a non-reference vehicle;
in response to determining that the target vehicle is the reference vehicle, adjusting the positioning location of the target vehicle according to the corresponding road;
in response to determining that the target vehicle has been the reference vehicle, adjusting the positioning location of the target vehicle according to the predicted location of the target vehicle in response to the predicted location of the target vehicle having the confidence level that is higher than a predetermined level; and
in response to determining that the target vehicle is the non-reference vehicle, adjusting the positioning location of the target vehicle according to at least one of the at least one record of the adjacent license plate information, the at least one record of the relative location information and the road attribute.

2. The positioning system according to claim 1, wherein the reference vehicle information includes the license plate information, pass time and a pass location of the vehicle passing by.

3. The positioning system according to claim 1, wherein each of the in-vehicle devices further includes a vehicle communication module configured to transmit the at least one record of the adjacent license plate information, the road attribute of the road, and the at least one record of the relative location information of the at least one adjacent vehicle to the server.

4. The positioning system according to claim 1, wherein the image recognition module is configured to:
identify the at least one adjacent vehicle from the driving image by using a first object recognition model;
calculate at least one relative location and at least one relative orientation of the at least one adjacent vehicle according to a location of the at least one adjacent vehicle in the driving image;
mark a location of a license plate of the at least one adjacent vehicle; and
identify, using a text recognition model, the at least one record of the adjacent license plate information corresponding to the at least one adjacent vehicle.

5. The positioning system according to claim 1, wherein the image recognition module is configured to recognize the road attribute of the road from the driving image by using a second object recognition model, and the road attribute includes a road type and a quantity of lanes.

6. The positioning system according to claim 1, wherein in the step of adjusting the positioning location of the target vehicle according to at least one of the at least one record of the adjacent license plate information, the at least one record of the relative location information and the road attribute, the positioning adjustment module is further configured to perform the following steps for each of the at least one adjacent vehicle:
determining, according to the at least one record of the adjacent license plate information, whether the at least one adjacent vehicle is the reference vehicle, or the at least one adjacent vehicle has been the reference vehicle and the confidence level of the corresponding predicted location is higher than the predetermined level;
in response to determining that the target vehicle is the reference vehicle, adjusting the positioning location of the target vehicle according to the road and the at least one relative location that correspond to the at least one adjacent vehicle; and
in response to determining that the at least one adjacent vehicle has been the reference vehicle and the confidence level of the corresponding predicted location is higher than the predetermined level, adjusting the positioning location of the target vehicle according to the positioning location, the at least one relative location and the predicted location of the at least one adjacent vehicle.

7. The positioning system according to claim 6, wherein in response to determining that the at least one adjacent vehicle is not the reference vehicle, and the at least one adjacent vehicle has not been the reference vehicle and the confidence level of the corresponding predicted location is not higher than the predetermined level, the positioning adjustment module is further configured to perform the following steps:
obtaining map data;
obtaining at least one optional road in a predetermined region near the positioning position according to the positioning position and the map data that correspond to the target vehicle;
filtering the at least one optional road according to the road attribute corresponding to the target vehicle to obtain a target route; and
adjusting the positioning location of the target vehicle according to the target route.

8. The positioning system according to claim 1, wherein in the step of performing the location prediction to generate the predicted location, and to calculate the confidence level corresponding to the predicted position, the location predicting module is further configured to:
obtain the positioning location, vehicle movement information and the road attribute, the at least one record of the adjacent license plate information and the at least one relative position information from the plurality of in-vehicle devices; and
executing a location predicting calculation model to generate the predicted location of each of the reference vehicles according to all the positioning locations, the vehicle movement information, the road attributes, the reference vehicle information, the at least one record of the adjacent license plate information and the at least one record of the relative position information that are obtained, and to use a prediction interval to calculate the confidence level of the predicted position.

9. The positioning system according to claim 1, wherein the positioning device is a global positioning system (GPS) device, and the positioning location is a GPS location.

10. A positioning method based on radio frequency identification (RFID) techniques, the positioning method comprising:
mounting a plurality of in-vehicle devices on a plurality of vehicles, respectively, wherein each of the plurality of in-vehicle devices includes a positioning device, an image capturing device and an image recognition module;
performing the following steps for each of the in-vehicle devices:
configuring the positioning device to obtain a positioning location;
configuring the image capturing device to capture a driving image from a surrounding environment of the corresponding vehicle; and
configuring the image recognition module to identify at least one adjacent vehicle, at least one record of adjacent license plate information, and a road attribute of a road from the driving image, and to calculate at least one record of relative location information of the at least one adjacent vehicle;
configuring each of a plurality of RFID readers to read a vehicle tag of one of the vehicles passing by, so as to mark the vehicle passing by as a reference vehicle and generate reference vehicle information corresponding to the vehicle passing by; and
configuring a server to communicatively connected with the plurality of RFID readers and each of the plurality of in-vehicle devices;
configuring a location predicting module of the server to, for each of multiple ones of the reference vehicles, perform a location prediction to generate a predicted location, and to calculate a confidence level corresponding to the predicted location; and
configuring a positioning adjustment module to perform the following steps for a target vehicle among the plurality of vehicles:
determining whether the target vehicle is the reference vehicle, has been the reference vehicle or is a non-reference vehicle;
in response to determining that the target vehicle is the reference vehicle, adjusting the positioning location of the target vehicle according to the corresponding road;
in response to determining that the target vehicle has been the reference vehicle, adjusting the positioning location of the target vehicle according to the predicted location of the target vehicle in response to the predicted location of the target vehicle having the confidence level that is higher than a predetermined level; and
in response to determining that the target vehicle is the non-reference vehicle, adjusting the positioning location of the target vehicle according to at least one of the at least one record of the adjacent license plate information, the at least one record of the relative location information and the road attribute.

11. The positioning method according to claim 10, wherein the reference vehicle information includes the license plate information, pass time and a pass location of the vehicle passing by.

12. The positioning method according to claim 10, wherein each of the in-vehicle devices further includes a vehicle communication module configured to transmit the at least one record of the adjacent license plate information, the road attribute of the road, and the at least one record of the relative location information of the at least one adjacent vehicle to the server.

13. The positioning method according to claim 10, further comprising:
configuring the image recognition module to perform:
identifying the at least one adjacent vehicle from the driving image by using a first object recognition model;
calculating at least one relative location and at least one relative orientation of the at least one adjacent vehicle according to a location of the at least one adjacent vehicle in the driving image;
marking a location of a license plate of the at least one adjacent vehicle; and
using a text recognition model to identify the at least one record of the adjacent license plate information corresponding to the at least one adjacent vehicle.

14. The positioning method according to claim 10, wherein the image recognition module is configured to recognize the road attribute of the road from the driving image by using a second object recognition model, and the road attribute includes a road type and a quantity of lanes.

15. The positioning method according to claim 10, wherein the step of adjusting the positioning location of the target vehicle according to at least one of the at least one record of the adjacent license plate information, the at least one record of the relative location information and the road attribute, further includes configuring the positioning adjustment module to perform the following steps for each of the at least one adjacent vehicle:
determining, according to the at least one record of the adjacent license plate information, whether the at least one adjacent vehicle is the reference vehicle, or the at least one adjacent vehicle has been the reference vehicle and the confidence level of the corresponding predicted location is higher than the predetermined level;
in response to determining that the target vehicle is the reference vehicle, adjusting the positioning location of the target vehicle according to the road and the at least one relative location that correspond to the at least one adjacent vehicle; and
in response to determining that the at least one adjacent vehicle has been the reference vehicle and the confidence level of the corresponding predicted location is higher than the predetermined level, adjusting the positioning location of the target vehicle according to the positioning location, the at least one relative location and the predicted location of the at least one adjacent vehicle.

16. The positioning method according to claim 15, wherein in response to determining that the at least one adjacent vehicle is not the reference vehicle, and the at least one adjacent vehicle has not been the reference vehicle and the confidence level of the corresponding predicted location is not higher than the predetermined level, the positioning adjustment module is further configured to perform the following steps:
obtaining map data;
obtaining at least one optional road in a predetermined region near the positioning position according to the positioning position and the map data that correspond to the target vehicle;
filtering the at least one optional road according to the road attribute corresponding to the target vehicle to obtain a target route; and
adjusting the positioning location of the target vehicle according to the target route.

17. The positioning method according to claim 10, wherein the step of performing the location prediction to generate the predicted location, and to calculate the confidence level corresponding to the predicted position further includes configuring the location predicting module to:
obtain the positioning location, vehicle movement information and the road attribute, the at least one record of the adjacent license plate information and the at least one relative position information from the plurality of in-vehicle devices; and
executing a location predicting calculation model to generate the predicted location of each of the reference vehicles according to all the obtained positioning locations, the vehicle movement information, the road attributes, the reference vehicle information, the at least one record of the adjacent license plate information and the at least one record of the relative position information that are obtained, and to use a prediction interval to calculate the confidence level of the predicted position.

18. The positioning method according to claim 10, wherein the positioning device is a global positioning system (GPS) device, and the positioning location is a GPS location.
